(19) United States
(12) Patent Application Publication
(10) Pub. No.: US 2024/0029003 A1
(43) Pub. Date: Jan. 25, 2024

(54) INFRASTRUCTURE MANAGEMENT SYSTEM, INFRASTRUCTURE MANAGEMENT METHOD, AND RECORDING MEDIUM

(71) Applicant: NEC Corporation, Minato-ku, Tokyo (JP)

(72) Inventors: Maiko HASEGAWA, Tokyo (JP); Nana JUMONJI, Tokyo (JP); Chisato SUGAWARA, Tokyo (JP); Yosuke KIMURA, Tokyo (JP)

(73) Assignee: NEC Corporation, Minato-ku, Tokyo (JP)

(21) Appl. No.: 18/266,365

(22) PCT Filed: Dec. 17, 2020
(86) PCT No.: PCT/JP2020/047080

§ 371 Date: Jun. 9, 2023

(51) Int. Cl. G06Q 10/0639

(52) U.S. Cl. CPC G06Q 10/06393

(57) ABSTRACT

An infrastructure management system includes an information acquisition unit, a ranking unit, and a display control unit. The information acquisition unit acquires management information indicating an infrastructure management state of each of a plurality of companies. The ranking unit calculates a score pertaining to the management state of each of the plurality of companies, on the basis of the management information for each of the plurality of companies, and ranks the plurality of companies according to the calculated scores. The display control unit displays the rankings of the plurality of companies on a display means.

### TECHNICAL FIELD

The present disclosure relates to an infrastructure management system, an infrastructure management method, and a recording medium.

### BACKGROUND ART

Many infrastructures (hereinafter, also referred to as infrastructure) such as roads, bridges, tunnels, water supply, electricity, and gas supply networks are approaching their service life. Therefore, many companies such as public institutions, local governments, and management companies that manage these infrastructures allocate budget and labor to inspection and maintenance (mending, repairing, etc.) of the infrastructures.

As such a technique for grasping a management state by inspection and maintenance of an infrastructure, PTL 1 discloses a technique for calculating evaluation information for a plurality of roads to be evaluated and indicating the order of the plurality of roads.

### CITATION LIST

### Patent Literature

PTL 1: JP 2018-181063 A

### SUMMARY OF INVENTION

### Technical Problem

Each company is required to efficiently perform inspection and maintenance within a range in which the management state of the infrastructure is appropriately maintained due to budget constraints. As one method for determining whether the management state of the infrastructure is appropriate, for example, it is conceivable to compare the management state of the infrastructure with other companies.

However, in the technique described in PTL 1, it is not disclosed to compare the management state of the infrastructure between different companies.

One object of the present disclosure is to provide an infrastructure management system, an infrastructure management method, and a recording medium capable of solving the above-described problems and comparing management states of an infrastructure between companies.

### Solution to Problem

An infrastructure management system according to an aspect of the present disclosure includes: an acquisition means configured to acquire management information indicating a management state of an infrastructure of each of a plurality of companies; a ranking means configured to calculate a score regarding a management state of each of the plurality of companies based on the management information of each of the plurality of companies, and rank the plurality of companies according to the calculated score; and a display control means configured to display a ranking of each of the plurality of companies on a display means.

An infrastructure management method according to an aspect of the present disclosure includes: acquiring management information indicating a management state of an infrastructure of each of a plurality of companies; calculating a score regarding a management state of each of the plurality of companies based on the management information of each of the plurality of companies, and ranking the plurality of companies according to the calculated score; and displaying a ranking of each of the plurality of companies on a display means.

A recording medium according to one aspect of the present disclosure has a program stored therein to cause a computer to execute: acquiring management information indicating a management state of an infrastructure of each of a plurality of companies; calculating a score regarding a management state of each of the plurality of companies based on the management information of each of the plurality of companies, and ranking the plurality of companies according to the calculated score; and displaying a ranking of each of the plurality of companies on a display means.

### Advantageous Effects of Invention

An effect of the present disclosure is to be able to compare the management state of the infrastructure among the companies.

### BRIEF DESCRIPTION OF DRAWINGS

FIG. 1 is a block diagram illustrating a configuration of an infrastructure management system 10 according to a first example embodiment.

FIG. 2 is a block diagram illustrating a configuration of a ranking device 11 according to the first example embodiment.

FIG. 3 is a diagram illustrating an example of group information according to the first example embodiment.

FIG. 4 is a diagram illustrating an example of management information (city A) according to the first example embodiment.

FIG. 5 is a diagram illustrating an example of score calculation according to the first example embodiment.

FIG. 6 is a flowchart illustrating ranking processing according to the first example embodiment.

FIG. 7 is a diagram illustrating an example of a ranking screen according to the first example embodiment.

FIG. 8 is a diagram illustrating an example of a message displayed together with the ranking screen according to the first example embodiment.

FIG. 9 is a diagram illustrating an example of group information in a second modification of the first example embodiment.

FIG. 10 is a diagram illustrating an example of score calculation in the second modification of the first example embodiment.

FIG. 11 is a diagram illustrating an example of a ranking screen in a second modification of the first example embodiment.

FIG. 12 is a block diagram illustrating a configuration of a ranking device 21 according to a second example embodiment.

FIG. 13 is a diagram illustrating an example of company attribute information according to the second example embodiment.

FIG. 14 is a diagram illustrating an example of coefficient information according to the second example embodiment.

FIG. 15 is a flowchart illustrating score calculation processing (step S104) according to the second example embodiment.

FIG. 16 is a diagram illustrating an example of score calculation according to the second example embodiment.

FIG. 17 is a diagram illustrating an example of a ranking screen according to the second example embodiment.

FIG. 18 is a flowchart illustrating score calculation processing (step S104) according to a third example embodiment.

FIG. 19 is a diagram illustrating an example of score calculation according to the third example embodiment.

FIG. 20 is a diagram illustrating an example of a ranking screen according to the third example embodiment.

FIG. 21 is a block diagram illustrating a configuration of a ranking device 31 according to a fourth example embodiment.

FIG. 22 is a flowchart illustrating ranking processing according to the fourth example embodiment.

FIG. 23 is a diagram illustrating an example of a company selection screen according to the fourth example embodiment.

FIG. 24 is a block diagram illustrating a configuration of an infrastructure management system 10 according to a fifth example embodiment.

FIG. 25 is a block diagram illustrating an example of a hardware configuration of a computer 500.

### EXAMPLE EMBODIMENT

Hereinafter, example embodiments will be described in detail with reference to the drawings. In the drawings and the example embodiments described in the specification, the same reference numerals are given to the same components, and the description thereof will be omitted as appropriate.

In the following example embodiments, the infrastructure is, for example, a road, a structure such as a railway, a harbor, a dam, a tunnel, a bridge, or an embankment, a building such as a house, or a supply network of electricity, gas, or water supply. A company is, for example, a public institution, a local government, a management company, or the like that manages these infrastructures. The infrastructure managed by each company may include a plurality of management targets.

Hereinafter, a case where a company is a road management department of a city, an infrastructure is a road, and a management target is each section obtained by subdividing a road in the city will be described as an example.

### First Example Embodiment

A First Example Embodiment Will be Described.

(System Configuration)

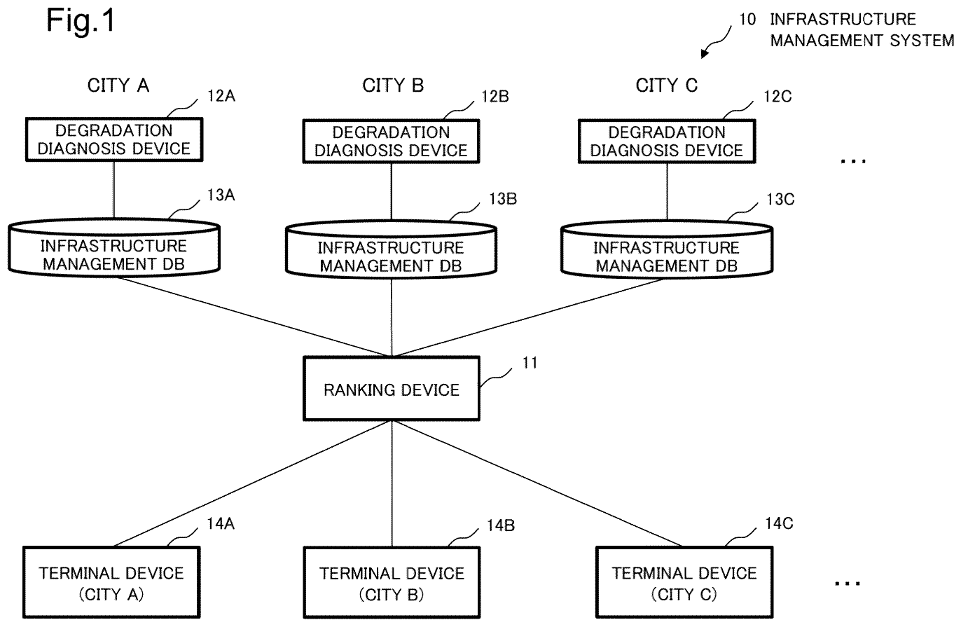

First, a configuration of an infrastructure management system according to the first example embodiment will be described. FIG. 1 is a block diagram illustrating a configuration of an infrastructure management system 10 according to the first example embodiment. Referring to FIG. 1, the infrastructure management system 10 includes a ranking device 11, degradation diagnosis devices 12A, 12B, . . . (Hereinafter, collectively referred to as a degradation diagnosis device 12), infrastructure management DBs (databases) 13A, 13B, . . . (Hereinafter, collectively referred to as an infrastructure management DB 13), and terminal devices 14A, 14B, . . . (Hereinafter, collectively referred to as a terminal device 14). Here, the degradation diagnosis devices 12A, 12B, . . . , the infrastructure management DBs 13A, 13B, . . . , and the terminal devices 14A, 14B, . . . are the degradation diagnosis devices 12, the infrastructure management DB, and the terminal devices 14 used by the road management departments or the like of city A, city B, . . . , which are companies.

The ranking device 11, the degradation diagnosis device 12, and the infrastructure management DB 13 are achieved by, for example, a computer on a cloud. The terminal device 14 is installed, for example, in each company. The terminal device 14 and the ranking device 11 are connected by, for example, a communication network. Similarly, the ranking device 11 and the infrastructure management DB 13 are also connected by a communication network. The infrastructure management DB 13 and the degradation diagnosis device 12 are also connected by a communication network. The degradation diagnosis device 12 and the infrastructure management DB 13 may be achieved by a computer installed in each company. The degradation diagnosis device 12 and the infrastructure management DB 13 used by a plurality of companies may be achieved by one computer.

The degradation diagnosis device 12 collects information of each management target of the infrastructure using various sensors, diagnoses a degradation state of each management target based on the collected information, and calculates a degradation index indicating the degradation state. As the various sensors, for example, an imaging device, a laser scanner, an ultrasonic inspection device, an accelerometer, or the like is used.

The infrastructure management DB 13 stores management information of each company. The management information indicates a management state of the infrastructure. The management information includes a value of the degradation index of each management target calculated by the degradation diagnosis device 12 as the management state of each management target of the infrastructure. The management information may further include a value of an attribute (Hereinafter, also described as management attribute) assigned to each management target.

For example, in the management information, a value of a degradation index and a value of an attribute of a section (Hereinafter, also described as section attribute) are set for each section of a road. Details of the management information will be described later.

The ranking device 11 ranks the predetermined companies included in the group information as to the management state of the infrastructure based on the management information of the infrastructure of each company stored in the infrastructure management DB 13.

The terminal device 14 requests the ranking device 11 to perform ranking. Then, the terminal device 14 displays the ranking by the ranking device 11 on a display unit (not illustrated) such as a display.

(Configuration of Ranking Device 11)

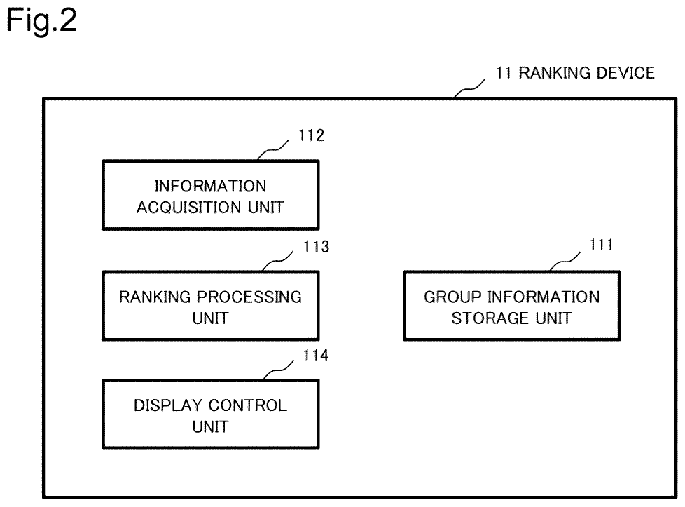

A configuration of the ranking device 11 according to the first example embodiment will be described. FIG. 2 is a block diagram illustrating a configuration of the ranking device 11 in the first example embodiment. Referring to FIG. 2, the ranking device 11 includes a group information storage unit 111, an information acquisition unit 112, a ranking processing unit 113, and a display control unit 114.

The group information storage unit 111 stores group information that is information on the grouped companies.

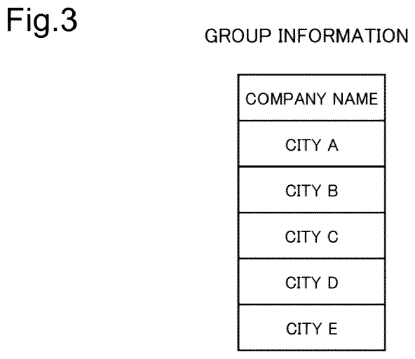

FIG. 3 is a diagram illustrating an example of group information according to the first example embodiment. As illustrated in FIG. 3, the company name of the company included in the group is set in the group information. For example, companies having similar scales and environments are selected and set in advance as the group information. A randomly selected company may be set in the group information. Here, as an example of a group of companies, city A to city E are grouped.

The information acquisition unit 112 acquires the group information from the group information storage unit 111. The information acquisition unit 112 acquires management information of each company included in the group information from the infrastructure management DB 13.

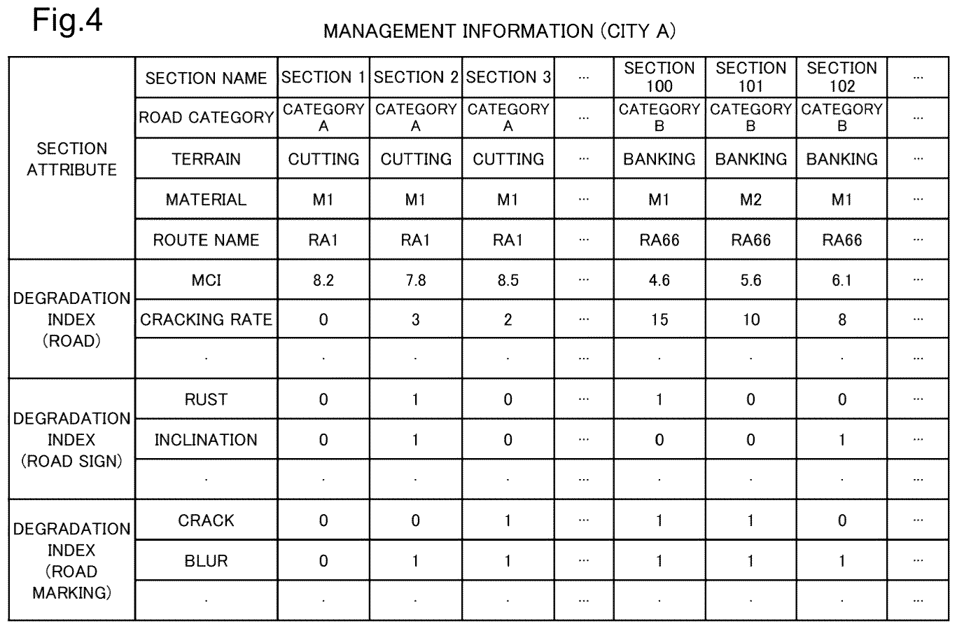

FIG. 4 is a diagram illustrating an example of management information (city A) according to the first example embodiment. As illustrated in FIG. 4, for example, for each of the plurality of sections, a section name of the section, a section attribute related to the section, and a degradation index of the section are set in association with each other in the management information.

In the section attribute, for example, road categories, terrain, materials, and route names are set. The road category indicates, for example, a category that defines a structure of a road and is determined according to a type of a road or a traffic volume by law or the like. The terrain indicates, for example, a method (cutting, banking, etc.) according to the terrain. The material indicates a material used for pavement of a road surface. The route name indicates the name of the route to which the section belongs.

As the degradation index, for example, an index indicating a state of road degradation is set. For example, a maintenance control index (MCI), a cracking rate, an international roughness index (IRI), or the like is used as an index indicating a state of road degradation.

As illustrated in the example of the management information of FIG. 4, for example, the presence or absence of “rust”, “inclination”, or the like indicating the degradation state of the road sign, and the presence or absence of “crack”, “blur”, or the like indicating the degradation state of the road marking may be used as the other degradation index. Here, in the degradation diagnosis, “1” is set to a section in which each of “rust” and “inclination” of the road sign is detected, and “0” is set to a section in which each of “rust” and “inclination” is not detected. Similarly, “1” is set to a section in which each of “crack” and “blur” is detected for the road marking, and “0” is set to a section in which each of “crack” and “blur” is not detected.

Although the degradation indexes of “rust” and “inclination” are represented by binary values (presence or absence of degradation), the invention is not limited thereto, and for example, values of three stages such as “0”, “1”, and “2” or more stages may be set according to the area ratio of rust to the sign surface and the degree of inclination of the sign. The degradation index of “crack” or “blur” is not limited to the binary value (presence or absence of degradation), and three or more levels of values may be set according to the area (size) of the crack on the road marking or the degree of blur.

The ranking processing unit 113 calculates an integrated degradation index related to the infrastructure for each company included in the group information based on the management information acquired from the information acquisition unit 112, and scores the calculated integrated degradation index. Here, the integrated degradation index is an index obtained by integrating the degradation index for each management target of each company. As the integrated degradation index, for example, a predetermined statistical value (For example, the average value) of degradation indexes related to all management targets in each company is used.

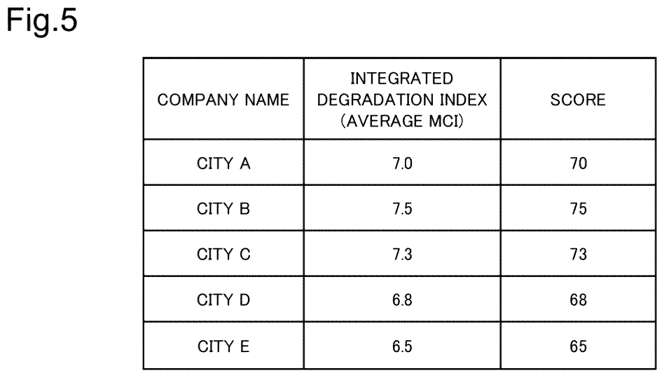

FIG. 5 is a diagram illustrating an example of score calculation according to the first example embodiment. In the example of FIG. 5, an average value (Hereinafter, also described as average MCI) of the MCIs of sections in all the sections is calculated as the integrated degradation index of each company. The average MCI is converted into a score such that the maximum value is 100 points and the minimum value is 0 points.

When degradation of a road sign is used as the integrated degradation index of each company, an average value of degradation indexes (rust and inclination) of sections in all the sections may be calculated. Similarly, when the degradation of the road marking is used as the integrated degradation index of each company, an average value of the degradation indexes (cracks and blurs) of sections in all the sections may be calculated. In this case, for example, these average values are converted into scores such that the minimum value is 100 points and the maximum value is 0 points.

The conversion method from the integrated degradation index to the score is not limited thereto, and other conversion methods may be used as long as the conversion method increases (or decreases) as the integrated degradation index increases.

Further, a score may be calculated from a plurality of integrated degradation indexes of each company. For example, a total value of scores obtained by converting average values in all the sections of each of “rust” and “inclination” of the road sign or a total value of scores obtained by converting average values in all the sections of each of “crack” and “blur” of the road marking may be calculated as the score.

The ranking processing unit 113 ranks the companies included in the group information based on the calculated score.

The display control unit 114 transmits the ranking screen displaying the ranking by the ranking processing unit 113 to the terminal device 14.

Next, an operation of the first example embodiment will be described.

(Ranking Processing)

Hereinafter, the ranking processing in the first example embodiment will be described.

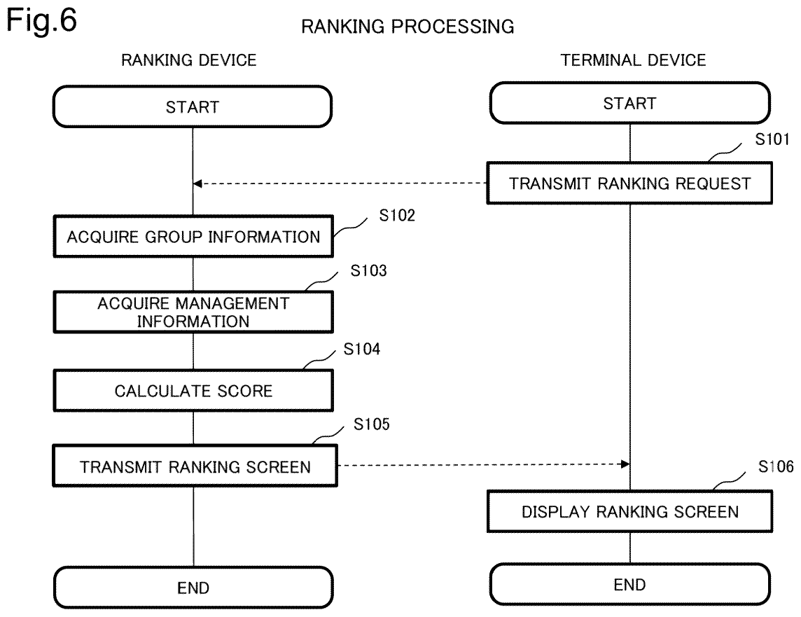

FIG. 6 is a flowchart illustrating the ranking processing according to the first example embodiment. The ranking processing is executed, for example, for each company to confirm the ranking of the company related to the management state of the infrastructure in a predetermined group including the company.

The terminal device 14 of the company transmits a ranking request to the ranking device 11 (step S101). For example, the terminal device 14A of city A transmits a ranking request to the ranking device 11.

When the ranking device 11 receives the ranking request from the terminal device 14, the information acquisition unit 112 acquires the group information including the company that has made the ranking request from the group information storage unit 111 (step S102). For example, the information acquisition unit 112 acquires group information including city A as illustrated in FIG. 3.

The information acquisition unit 112 acquires management information of each company included in the acquired group information from the infrastructure management DB 13 (step S103). For example, the information acquisition unit 112 acquires management information of city A as illustrated in FIG. 4 from the infrastructure management DB 13A. The information acquisition unit 112 acquires management information for other cities from the infrastructure management DB 13B, and so on.

The ranking processing unit 113 calculates an integrated degradation index based on the value of the degradation index included in the management information for each company, and calculates a score based on the integrated degradation index (step S104). For example, as illustrated in FIG. 5, the ranking processing unit 113 calculates a score based on the integrated degradation index (average MCI). The ranking processing unit 113 ranks the companies based on the calculated score.

For example, the ranking processing unit 113 ranks city A to city E in the order of city B, city C, city A, city D, and city E in descending order of the score in FIG. 5.

The display control unit 114 generates a ranking screen indicating the ranking by the ranking processing unit 113 and transmits the ranking screen to the terminal device 14 (step S105).

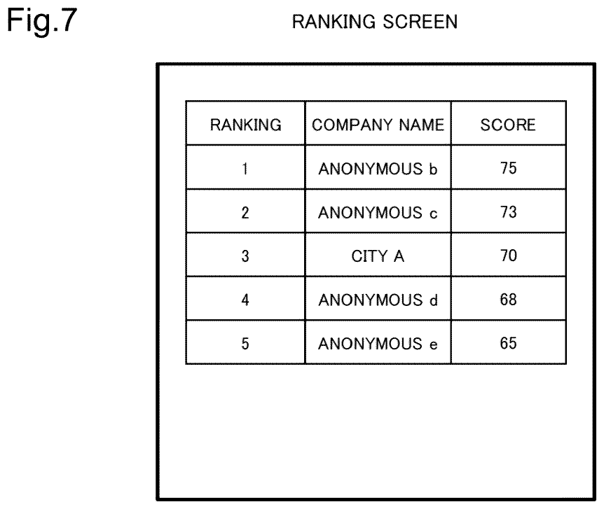

FIG. 7 is a diagram illustrating an example of a ranking screen according to the first example embodiment. In the example of FIG. 7, the company name and the score of the company in the rank are shown for each rank.

Here, the display control unit 114 may anonymize the company names other than the company that made the ranking request on the ranking screen. In the example of FIG. 7, city B, city C, city D, and city E other than city A are indicated by anonymity “Anonymous b”, “Anonymous c”, “Anonymous d”, and “Anonymous e”. For a company that agrees to disclose the ranking of its own company to other companies, the actual company name may be indicated without anonymizing the company name.

For example, the display control unit 114 generates a ranking screen as illustrated in FIG. 7 based on the ranking, and transmits the ranking screen to the terminal device 14A of city A.

The terminal device 14 displays the received ranking screen on the display unit (step S106). For example, the terminal device 14A of city A displays the ranking screen as illustrated in FIG. 7 received from the ranking device 11.

Thus, the operation of the first example embodiment is completed.

In the first example embodiment, the ranking is performed using the score based on the average MCI as the integrated degradation index, but the present invention is not limited thereto, and the scores based on the plurality of integrated degradation indexes may be summed up and ranked. For example, in the case of degradation of a road sign, scores based on the integrated degradation indexes of “rust” and “inclination” may be summed up to perform ranking.

In the above description of the ranking processing, the ranking device 31 performs the ranking when receiving the ranking request from the terminal device 14, but the present invention is not limited thereto. For example, the ranking device 31 may periodically (For example, every week or every month) repeat the ranking among the companies included in the group information and the transmission of the ranking screen to the terminal device 14 (update of the ranking screen displayed on the terminal device 14).

Next, effects of the first example embodiment will be described.

According to the first example embodiment, the management state of the infrastructure can be compared between companies. The reason is that the information acquisition unit 112 acquires the management information indicating the management state of the infrastructure of each of the plurality of companies, the ranking processing unit 113 calculates the score regarding the management state of each of the plurality of companies based on the management information of each of the plurality of companies, ranks the plurality of companies according to the calculated score, and the display control unit 114 displays the ranking of each of the plurality of companies on the display unit of the terminal device 14.

Several modifications are conceivable for the infrastructure management system 10 in the first example embodiment described above. Hereinafter, modifications will be described.

### First Modification of First Example Embodiment

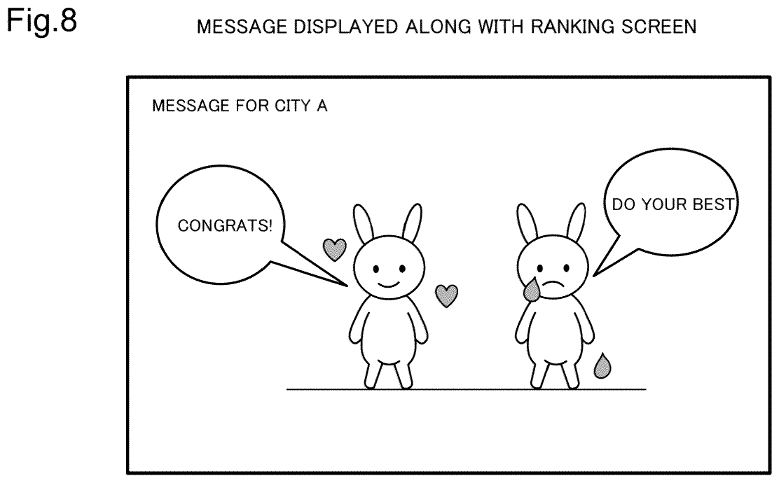

The display control unit 114 may display a message corresponding to the ranking of the company that has made the ranking request on the ranking screen. In this case, the display control unit 114 may display a predetermined character having an expression corresponding to the content of the message or a predetermined character corresponding to the content of the message together with the message. FIG. 8 is a diagram illustrating an example of a message displayed together with the ranking screen in the first example embodiment; As illustrated in FIG. 8, for example, the display control unit 114 displays a message regarding the rank together with a predetermined character. In this case, if the ranking of the company is high, the display control unit 114 may display a message praising the company, such as “congrats”, in a speech balloon of a happy character, for example. On the other hand, when the ranking of the company is low, the display control unit 114 may display a message encouraging the company, for example, “Do your best” in a speech balloon of a sad character.

The display control unit 114 may display, on the ranking screen, a message according to a change in the ranking of the company that has made the ranking request based on history information indicating a history of ranks stored in a storage unit (not illustrated). In this case, for example, the display control unit 114 may display a message for praising the company when the ranking of the company is higher than the previous ranking, and may display a message for encouraging the company when the rank of the company is lower.

In this way, by displaying the message according to the ranking of the company, it is possible to improve motivation of the manager and the worker related to inspection and maintenance in the company.

### Second Modification of First Example Embodiment

In the first example embodiment, the case where the infrastructure management system 10 ranks the companies included in the predetermined group has been described. The present invention is not limited thereto, and the infrastructure management system 10 may rank routes of companies included in a predetermined group.

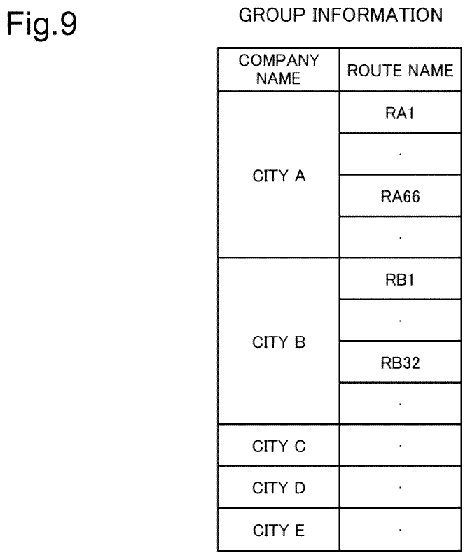

In this case, information on the grouped routes is used as the group information. FIG. 9 is a diagram illustrating an example of group information in the second modification of the first example embodiment. As illustrated in FIG. 9, the route name of the route of each company included in the group is set in the group information together with the company name. In the group information, for example, routes having the same road categories or the like are selected and set in advance in companies having similar scales and environments.

The information acquisition unit 112 acquires group information including the company that has made the ranking request from the group information storage unit 111. For example, the information acquisition unit 112 acquires group information including city A as illustrated in FIG. 9.

The ranking processing unit 113 calculates an integrated degradation index for each route included in the group information, and calculates a score based on the integrated degradation index.

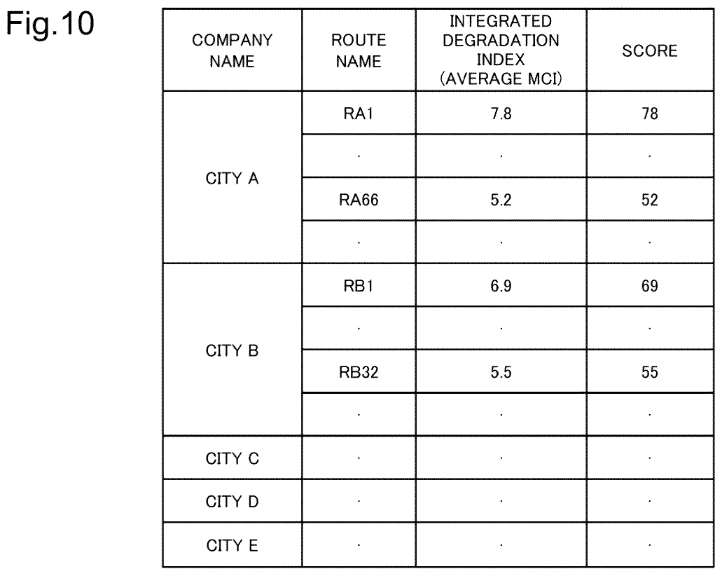

FIG. 10 is a diagram illustrating an example of score calculation in the second modification of the first example embodiment. In the example of FIG. 10, as the integrated degradation index of each route, the average MCI of the MCIs of sections of the route in all the sections is calculated.

The ranking processing unit 113 ranks the routes included in the group information based on the calculated score.

The display control unit 114 transmits the ranking screen displaying the rankings of the routes by the ranking processing unit 113 to the terminal device 14.

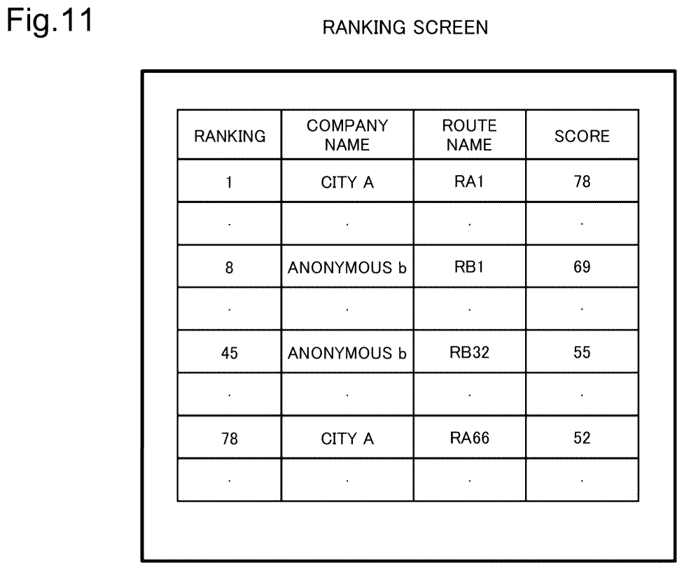

FIG. 11 is a diagram illustrating an example of a ranking screen in the second modification of the first example embodiment. In the example of FIG. 11, the company name of the company managing the route of the rank, the route name of the route, and the score are illustrated for each rank.

For example, the display control unit 114 generates a ranking screen as illustrated in FIG. 11 based on the rankings of routes and transmits the screen to the terminal device 14A of city A. The terminal device 14A of city A displays the ranking screen as illustrated in FIG. 11 received from the ranking device 11.

### Second Example Embodiment

A second example embodiment will be described.

In the second example embodiment, the score of the company is calculated using management information of the company and a coefficient corresponding to a value of a predetermined attribute (Hereinafter, it is also described as a company attribute) of the company.

(Configuration of Ranking Device 21)

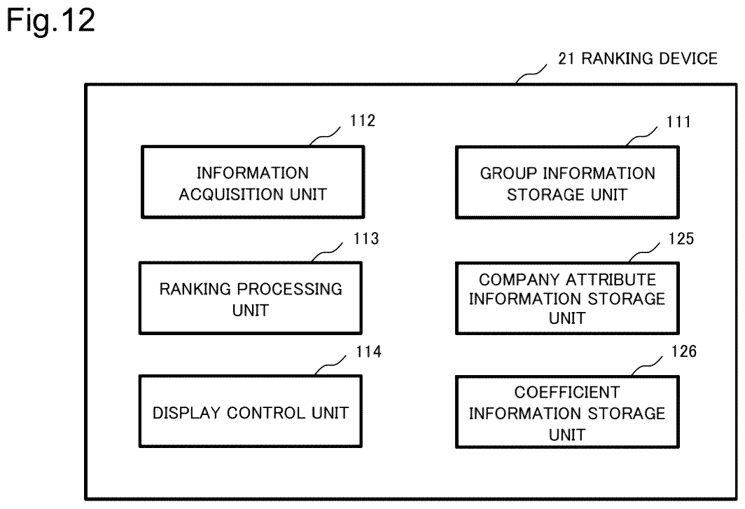

FIG. 12 is a block diagram illustrating a configuration of a ranking device 21 in the second example embodiment.

The infrastructure management system 10 in the second example embodiment includes the ranking device 21 instead of the ranking device 11 of the infrastructure management system 10 in the first example embodiment. As illustrated in FIG. 12, the ranking device 21 further includes a company attribute information storage unit 125 and a coefficient information storage unit 126 in addition to the configuration (FIG. 2) of the ranking device 11 according to the first example embodiment. In the second example embodiment, only portions different from those of the first example embodiment will be described with reference to FIG. 12.

In addition to the group information and the management information, the information acquisition unit 112 acquires the company attribute information from the company attribute information storage unit 125 and acquires the coefficient information from the coefficient information storage unit 126.

The company attribute information storage unit 125 stores the company attribute information. The company attribute information indicates a value of the company attribute. As the company attribute, for example, an attribute related to climate of an area to which a road managed by a company belongs, an attribute related to the terrain of the area, an attribute related to a road length managed by a company, an attribute related to a road category of a road managed by a company, and the like are used. Here, the attribute related to climate is, for example, an attribute indicating whether it is a heavy snow area. The attribute related to the terrain is, for example, an attribute indicating whether it is a mountain area.

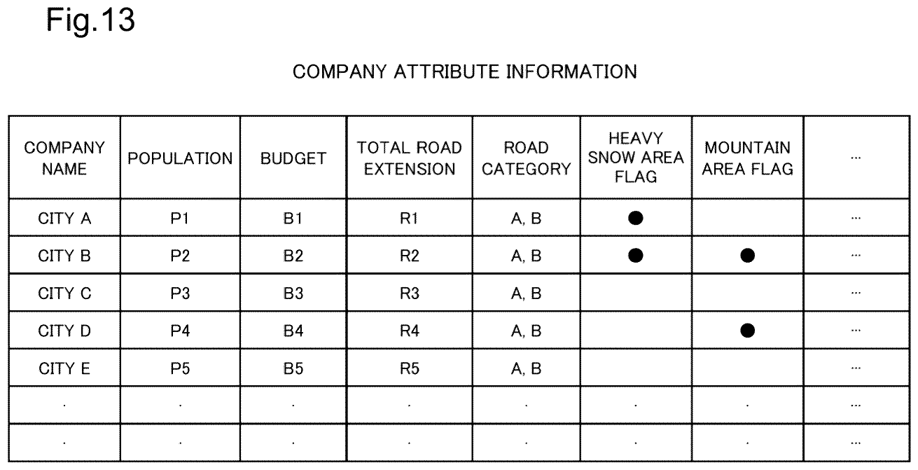

FIG. 13 is a diagram illustrating an example of company attribute information according to the second example embodiment. In the example of FIG. 13, as the company attribute, the company name of each company is set in association with the population, the budget, the total road extension, the road category, the heavy snow area flag, the mountain area flag, and the like of the company. Here, the road categories managed by the company are set as the road categories. In the heavy snow area flag and the mountain area flag, whether the company corresponds to each of the heavy snow area and the mountain area is set. Here, a circle is provided in each case.

For example, when the amount of snow accumulated in the area managed by the company is equal to or more than a predetermined value, the area may correspond to a heavy snow area. For example, in a case where an area of a predetermined altitude or higher is a predetermined value or a ratio or higher based on terrain data of an area managed by a company, the area may correspond to a mountain area.

The coefficient information storage unit 126 stores coefficient information. The coefficient information indicates a coefficient corresponding to the value of the company attribute. The coefficient may be a value to be added to or multiplied by the integrated degradation index when the ranking processing unit 113 calculates the score, or may be a value to be added to or multiplied by the score based on the integrated degradation index. The coefficient information may include a combination of a value of a coefficient to be added and a value of a coefficient to be multiplied by the integrated degradation index or a score based on the integrated degradation index. The value of the coefficient is set such that the score becomes larger (or smaller) in a case where more effort is required for the management of the infrastructure or in a case where degradation is more likely to occur according to the value of the company attribute such as a heavy snow area or a mountain area.

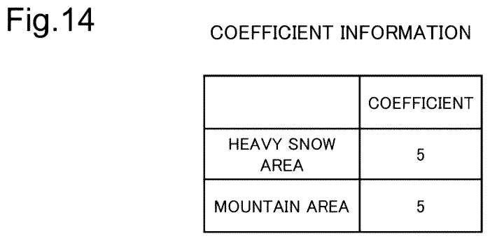

FIG. 14 is a diagram illustrating an example of coefficient information according to the second example embodiment. In the example of FIG. 14, the value of the coefficient used when the company corresponds to each of the heavy snow area and the mountain area is set.

The coefficient may be set for each predetermined range of the value of the company attribute. For example, the coefficient may be increased (or decreased) for each range in which the population is 10,000 or more and less than 30,000, 30,000 or more and less than 50,000, 50,000 or more and less than 100,000, 100,000 or more and less than 300,000, or the like.

For each company included in the group information, the ranking processing unit 113 calculates the score of the company using the management information of the company and the coefficient corresponding to the value of the company attribute of the company (corrects the score using the coefficient).

Next, an operation of the second example embodiment will be described.

(Ranking Processing)

Hereinafter, the ranking processing in the second example embodiment will be described. In the ranking processing according to the second example embodiment, the score is calculated as follows in step S104 of the flowchart (FIG. 6) of the ranking processing according to the first example embodiment. Here, it is assumed that the group information of FIG. 3 and the management information of FIG. 4 are acquired by the information acquisition unit 112. Here, the ranking processing unit 113 corrects the score using the coefficient in the case of a heavy snow area and a mountain area.

### Score Calculation Processing

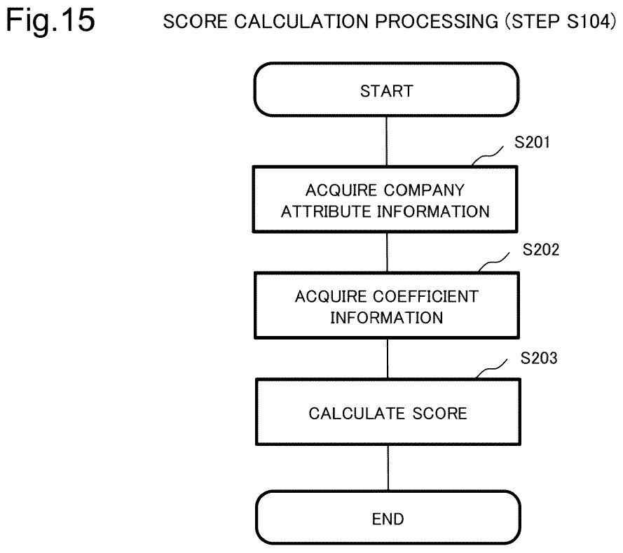

FIG. 15 is a flowchart illustrating score calculation processing (step S104) in the second example embodiment.

The information acquisition unit 112 of the ranking device 21 acquires the company attribute information from the company attribute information storage unit 125 (step S201). For example, the information acquisition unit 112 acquires the company attribute information as illustrated in FIG. 13. Here, as illustrated in FIG. 13, the heavy snow areas are city A and city B, and the mountain areas are city B and city D.

The information acquisition unit 112 acquires coefficient information from the coefficient information storage unit 126 (step S202). For example, the information acquisition unit 112 acquires coefficient information as illustrated in FIG. 14.

The ranking processing unit 113 calculates a score using the management information and a coefficient corresponding to the value of the company attribute information (step S203). Here, the ranking processing unit 113 acquires the value of the coefficient from the coefficient information. For example, the ranking processing unit 113 acquires the coefficient “5” for each of the heavy snow area and the mountain area from the coefficient information in FIG. 14. The ranking processing unit 113 determines a company that corrects the score by using the coefficient based on the company attribute information. For example, the ranking processing unit 113 determines, from the company attribute information in FIG. 13, that a coefficient of the heavy snow area is used for the scores of city A and city B, and a coefficient of the mountain area is used for the scores of city B and city D.

The ranking processing unit 113 calculates a score from the integrated degradation index in the same manner as in the first example embodiment. Further, the ranking processing unit 113 corrects the score using the coefficient.

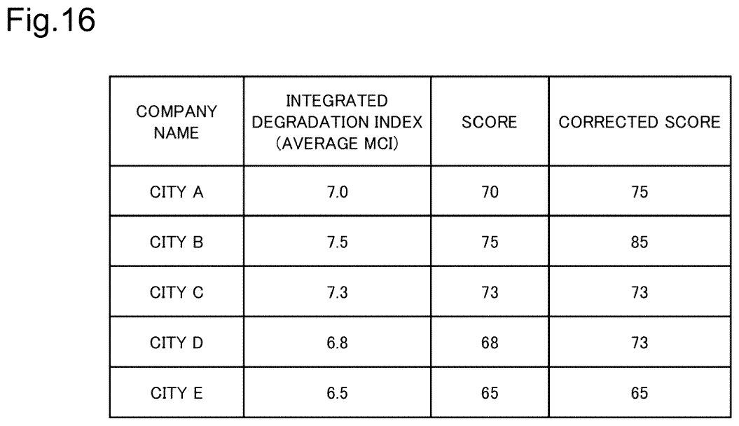

FIG. 16 is a diagram illustrating an example of score calculation according to the second example embodiment. For example, as illustrated in FIG. 16, the ranking processing unit 113 adds the coefficient “5” of the heavy snow area to the scores of city A and city B, and adds the coefficient “5” of the mountain area to the scores of city B and city D to correct the score.

The ranking processing unit 113 ranks the companies based on the corrected score. Then, the display control unit 114 generates a ranking screen based on the rankings of the companies by the ranking processing unit 113 and displays the screen on the terminal device 14.

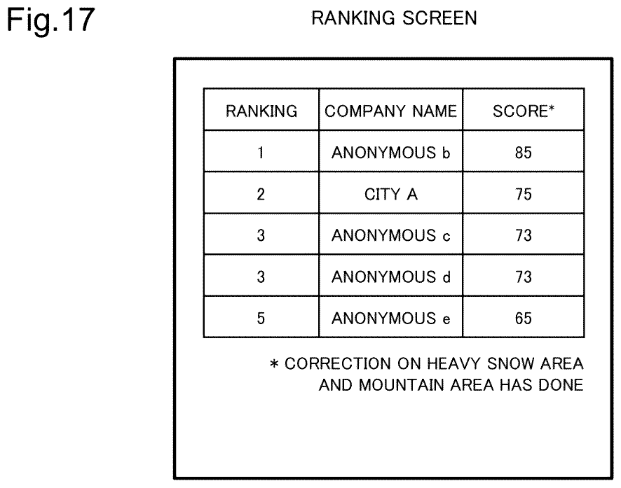

FIG. 17 is a diagram illustrating an example of a ranking screen according to the second example embodiment. For example, the display control unit 114 displays a ranking screen as illustrated in FIG. 17 on the terminal device 14 A of city A.

Thus, the operation of the second example embodiment is completed.

In the second example embodiment, the score based on the average MCI is ranked using the coefficient included in the coefficient information as the integrated degradation index, but the present invention is not limited thereto, and the score based on the integrated degradation index of each of the road sign and the road marking may be ranked using the coefficient.

Next, effects of the second example embodiment will be described.

According to the second example embodiment, it is possible to fairly compare the management state of the infrastructure even in a case where labor required for managing the infrastructure and the likelihood of occurrence of degradation are different between companies. This is because the ranking processing unit 113 calculates the score of each of the plurality of companies based on the management information of the company and the coefficient corresponding to the value of the predetermined company attribute information of the company.

### Third Example Embodiment

A third example embodiment will be described.

In the third example embodiment, the score of the company is calculated by summing the scores calculated for values of the predetermined management attribute.

The configuration of the ranking device 11 according to the third example embodiment is similar to the configuration of the ranking device 11 according to the first example embodiment (FIG. 2).

For each company included in the group information, the ranking processing unit 113 calculates the score of the management target to which each of the plurality of values of the predetermined management attribute is assigned, and calculates the score of the company by summing the scores calculated for each of the plurality of values. Here, as the predetermined management attribute, for example, an attribute in which labor required for management of the management target and the likelihood of occurrence of degradation are different depending on a value of the predetermined management attribute, such as a road category, a terrain, and a material, is used.

Next, an operation of the third example embodiment will be described.

(Ranking Processing)

Hereinafter, the ranking processing in the third example embodiment will be described. In the ranking processing according to the third example embodiment, the score is calculated as follows in step S104 of the flowchart (FIG. 6) of the ranking processing according to the first example embodiment. Here, it is assumed that the group information of FIG. 3 and the management information of FIG. 4 are acquired by the information acquisition unit 112. Here, it is assumed that the ranking processing unit 113 sums the scores calculated for each value of the road categories as the predetermined management attribute.

(Score Calculation Processing)

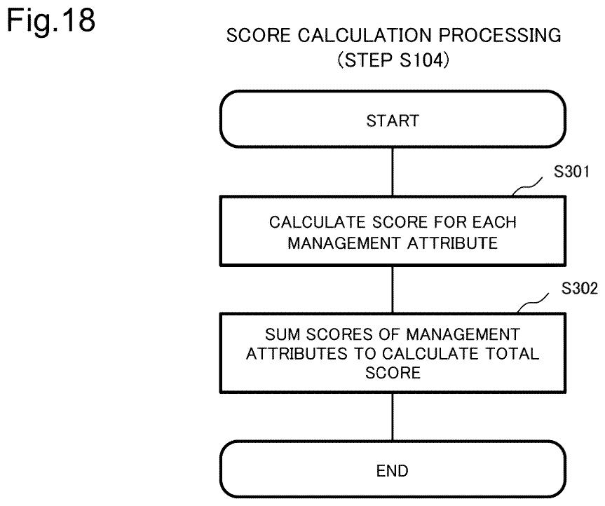

FIG. 18 is a flowchart illustrating score calculation processing (step S104) in the third example embodiment.

The ranking processing unit 113 calculates a score for each of the values of the predetermined management attributes of the management information (step S301). Here, the ranking processing unit 113 calculates, for each value of the predetermined management attribute, the integrated degradation index of the management target to which the value is given, and calculates the score based on the calculated integrated degradation index.

The ranking processing unit 113 sums the scores calculated for each of the values of the predetermined management attributes to calculate a total score (step S302).

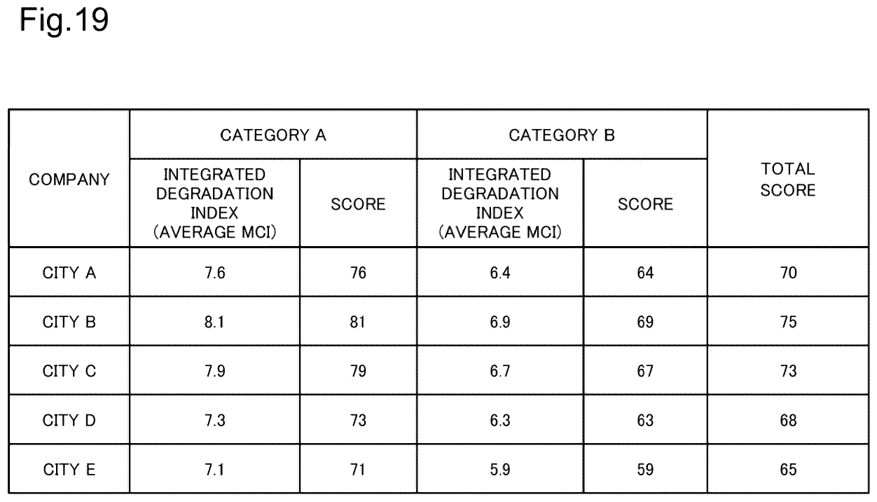

FIG. 19 is a diagram illustrating an example of score calculation according to the third example embodiment. In the example of FIG. 19, the management attribute is a road category, and the values of the management attribute are “category A” and “category B”. For example, as illustrated in FIG. 19, the ranking processing unit 113 calculates the average MCI of the road category “category A” and the average MCI of the road category “category B” as integrated degradation indexes for each company. The ranking processing unit 113 converts the average MCIs into scores such that the maximum value is 50 points and the minimum value is 0 points, and calculates a total score of the scores.

When converting the integrated degradation index calculated for each value of the management attribute into the score, the ranking processing unit 113 may set the maximum value of the score of each value of the management attribute to be the same (the weight for each value of the management attribute is the same) or may set the maximum value to be different (the weight for each value of the management attribute is different). In the example of FIG. 19, the number of values of the management attribute is not limited to two of “category A” and “category B”, and the number of values of the management attribute may be any number of 2 or more.

The ranking processing unit 113 ranks the companies based on the total score. Then, the display control unit 114 generates a ranking screen based on the rankings of the companies by the ranking processing unit 113 and displays the screen on the terminal device 14.

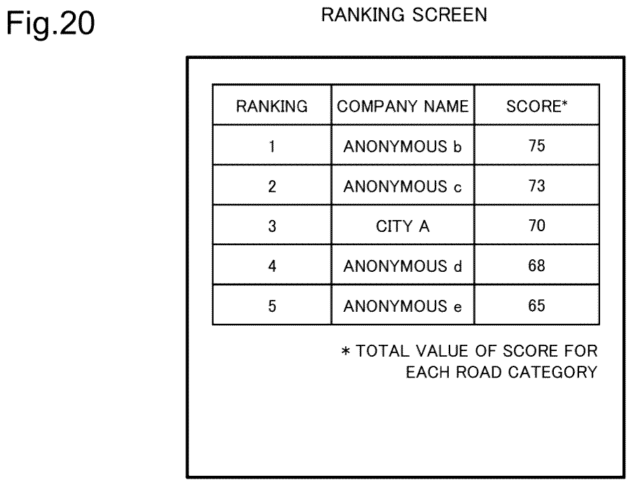

FIG. 20 is a diagram illustrating an example of a ranking screen according to the third example embodiment. For example, the display control unit 114 displays a ranking screen as illustrated in FIG. 20 on the terminal device 14 A of city A.

Thus, the operation of the third example embodiment is completed.

In the third example embodiment, the score based on the average MCI which is the integrated degradation index is calculated for each management attribute and the ranking is performed. However, the present invention is not limited thereto, and the ranking may be performed using the score based on the road sign or the road marking.

Next, effects of the third example embodiment will be described.

According to the third example embodiment, it is possible to fairly compare the management state of the infrastructure even in a case where there is a difference in the ratio of the management targets in which the labor required for the management of the infrastructure and the likelihood of occurrence of degradation are different between companies. The reason is that the ranking processing unit 113 calculates the score of the management target to which the value is given for each of the plurality of values of the predetermined management attribute of each of the plurality of companies, and calculates the score of the company by summing the scores calculated for each of the plurality of values.

The ranking processing unit 113 may calculate the score by combining the score calculation processing in the second example embodiment and the score calculation processing in the third example embodiment. In this case, for example, the ranking processing unit 113 calculates the score of each company by summing the scores calculated for each value of the predetermined management attribute for each company included in the group information, and corrects the calculated score using a coefficient corresponding to the value of the predetermined company attribute information of the company.

### Fourth Example Embodiment

A fourth example embodiment will be described.

In each of the above-described example embodiments, ranking of a plurality of companies included in predetermined group information is performed. In the fourth example embodiment, group information is generated according to a condition designated by a company who makes a ranking request, and ranking of companies included in the generated group information is performed.

(Configuration of Ranking Device 31)

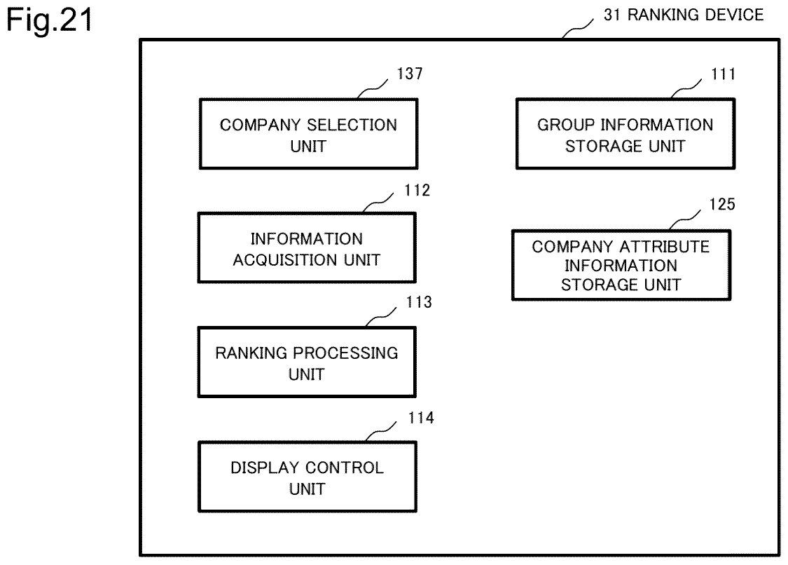

FIG. 21 is a block diagram illustrating a configuration of a ranking device 31 in the fourth example embodiment. The infrastructure management system 10 in the fourth example embodiment includes the ranking device 31 instead of the ranking device 11 of the infrastructure management system 10 in the first example embodiment. As illustrated in FIG. 21, the ranking device 31 further includes a company attribute information storage unit 125 and a company selection unit 137 in the configuration (FIG. 2) of the ranking device 11 according to the first example embodiment. In the fourth example embodiment, only portions different from those of the first example embodiment will be described with reference to FIG. 21.

The company attribute information storage unit 125 stores company attribute information, similarly to the company attribute information storage unit 125 according to the second example embodiment. The company included in the company attribute information is used as a candidate company for generating the group information.

The company selection unit 137 selects, from the candidate companies, a company having the same or similar value of the predetermined company attribute as the company making the ranking request. Here, for example, when the value of the predetermined company attribute of the candidate company falls within a predetermined range from the value of the predetermined company attribute of the company who makes the ranking request, the company selection unit 137 determines that the values of the predetermined company attributes are similar to each other. The company selection unit 137 generates group information including the company making the ranking request and the selected company.

Next, an operation of the fourth example embodiment will be described.

(Ranking Processing)

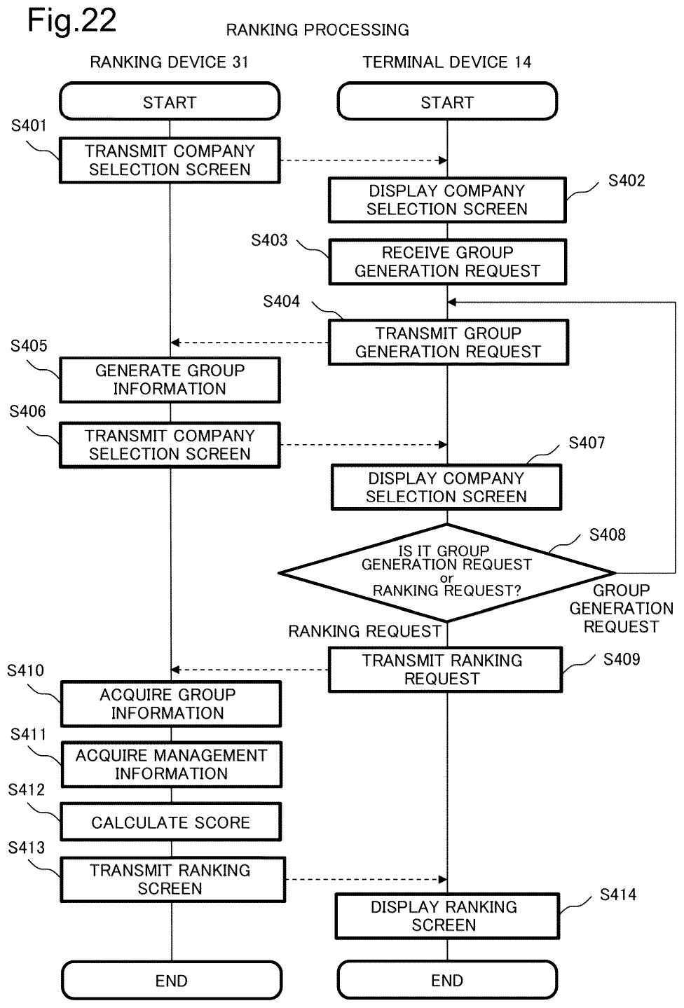

FIG. 22 is a flowchart illustrating ranking processing according to the fourth example embodiment. The ranking processing in the fourth example embodiment will be described below.

The display control unit 114 of the ranking device 31 generates a company selection screen and transmits the screen to the terminal device 14 (step S401). The company selection screen is a screen on which the company making the ranking request specifies a condition (selection condition) for selecting a company to be included in the group information prior to the ranking, and confirms the selected company. Here, as the selection condition, a company attribute to be a target for determining whether values are the same or similar is specified for the candidate company that transmits the ranking request.

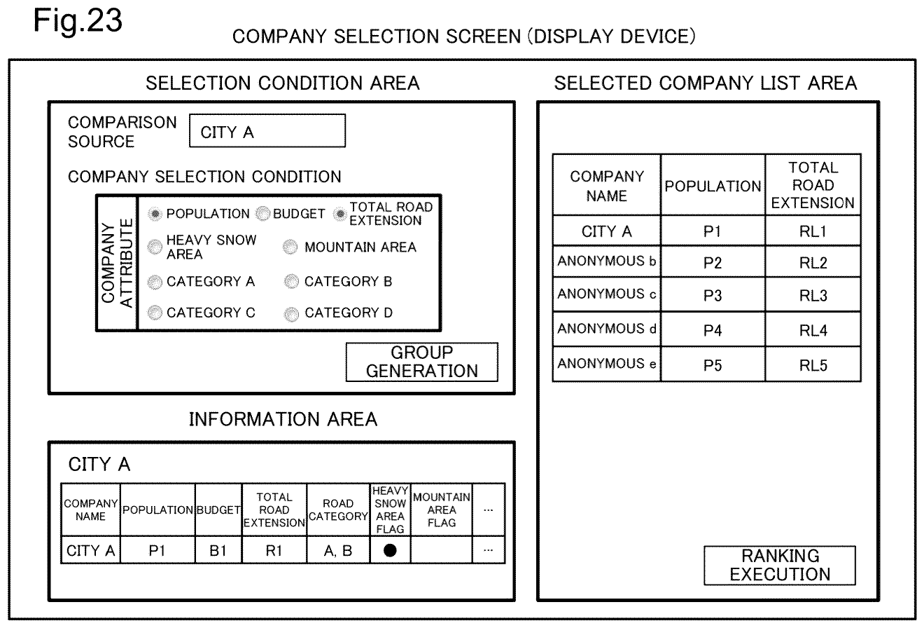

FIG. 23 is a diagram illustrating an example of a company selection screen in the fourth example embodiment. For example, as illustrated in FIG. 23, the company selection screen includes a selection condition area, an information area, and a selected company list area.

The selection condition area is an area for receiving designation of a selection condition. In the example of FIG. 23, a radio button for designating the company attribute (population, budget, total road extension, heavy snow area flag, mountain area flag, and road category) and a button (“group generation”) for making a group generation request with the designated company attribute as a selection condition are displayed. The form of designation of the company attribute is not limited to the radio button, and may be any form as long as the company attribute can be designated.

The information area is an area for displaying the company attribute of the company that makes the ranking request. In the example of FIG. 23, the value of the company attribute of city A is displayed so as to be referable. The present invention is not limited thereto, and any information may be displayed on the information screen as long as the information is useful for specifying the company attribute by the company that makes the ranking request.

The selected company list area is an area for displaying a list of companies included in the group information generated based on the designated selection condition and accepting a ranking request by the list. In the example of FIG. 23, a button (“ranking execution”) for making a ranking request by the list is displayed together with the list of the selected companies.

For example, the display control unit 114 transmits the company selection screen of FIG. 23 to the terminal device 14A in city A. In the initial state, the list of the companies is not displayed in the selected company list area.

The terminal device 14 displays the received company selection screen on the display unit (step S402). For example, the terminal device 14A of city A displays the company selection screen as illustrated in FIG. 23 received from the ranking device 31.

The terminal device 14 receives designation of a selection condition on the company selection screen. Then, the terminal device 14 receives the group generation request under the designated selection condition (step S403).

The designation of the selection condition and the reception of the group generation request in the terminal device 14 may be performed simultaneously. In this case, for example, in the selection condition area of the company selection screen of FIG. 23, the button for making the group generation request is omitted, and when the radio button of the company selection condition is selected, the terminal device 14 accepts the group generation request under the designated selection condition.

When receiving the group generation request, the terminal device 14 transmits the group generation request including the designated selection condition to the ranking device 31 (step S404). For example, the terminal device 14A of city A transmits the group generation request including selection conditions (company attributes) “population” and “total road extension” to the ranking device 31.

When the ranking device 31 receives the group generation request, the company selection unit 137 generates the group information based on the selection condition (step S405). The company selection unit 137 stores the generated group information in the group information storage unit 111. For example, the company selection unit 137 selects city B, city C, city D, and city E as companies in which each of “population” and “total road extension” is within a predetermined range from “population” and “total road extension” of city A, and generates group information including city A, city B, city C, city D, and city E.

The display control unit 114 updates the selected company list area of the company selection screen with the list of companies included in the generated group information, and transmits the updated company selection screen to the terminal device 14 (step S406). For example, as illustrated in FIG. 23, the display control unit 114 updates the selected company list area with a list of city A, city B, city C, city D, and city E. However, also in the selected company list area, the display control unit 114 may anonymize the company names of the companies other than the company who makes a ranking request (requests the group generation). In the example of FIG. 23, city B, city C, city D, and city E other than city A are indicated by anonymity “Anonymous b”, “Anonymous c”, “Anonymous d”, and “Anonymous e”.

The terminal device 14 displays the updated company selection screen on the display unit (step S407). For example, the terminal device 14A of city A displays the company selection screen as illustrated in FIG. 23 received from the ranking device 31.

The terminal device 14 receives the re-designation of the selection condition and the group generation request or the ranking request on the company selection screen (step S408).

In a case where the re-designation of the selection condition and the group generation request are accepted in step S408, the terminal device 14 repeats the processing from step S404.

On the other hand, when accepting the ranking request in step S408, the terminal device 14 transmits the ranking request to the ranking device 31 (step S409).

Thereafter, similarly to steps S102 to S106 described above, the ranking device 31 ranks the companies included in the generated group information, and the terminal device 14 displays the ranking screen (steps S410 to S414).

Thus, the operation of the fourth example embodiment is completed.

In the above description of the ranking processing, the group generation request is transmitted from the terminal device 14 to the ranking device 31 in step S404, the selected company list area of the company selection screen is updated, and then the ranking request is transmitted from the terminal device 14 to the ranking device 31 in step S408, but the present invention is not limited thereto. For example, the terminal device 14 may transmit the group generation request and the ranking request to the ranking device 31 as a single request (group generation+ranking request). In this case, for example, steps S406 to S408 described above are omitted, and the terminal device 14 transmits group generation+ranking request to the ranking device 31 in step S404. When receiving the group generation+ranking request, the ranking device 31 generates group information and ranks the companies included in the group information.

Next, effects of the fourth example embodiment will be described.

According to the fourth example embodiment, the company who requests the ranking can change the company to compare the management state of the infrastructure. The reason is that the company selection unit 137 selects, from the plurality of candidate companies, a company whose value of the predetermined company attribute designated from the company who makes the ranking request is the same as the value of the company or within a predetermined range from the value of the company, and generates the group information.

### Fifth Example Embodiment

A fifth example embodiment will be described.

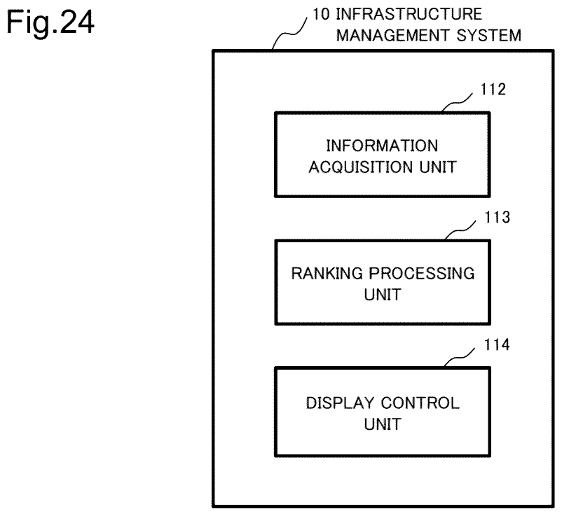

FIG. 24 is a block diagram illustrating a configuration of an infrastructure management system 10 according to the fifth example embodiment.

Referring to FIG. 24, the infrastructure management system 10 includes an information acquisition unit 112, a ranking processing unit 113, and a display control unit 114. The information acquisition unit 112, the ranking processing unit 113, and the display control unit 114 are example embodiments of an acquisition means, a ranking means, and a display control means.

The information acquisition unit 112 acquires management information indicating an infrastructure management state of each of a plurality of companies. The ranking processing unit 113 calculates a score pertaining to the management state of each of the plurality of companies, based on the management information for each of the plurality of companies, and ranks the plurality of companies according to the calculated scores. The display control unit 114 displays the rankings of the plurality of companies on a display means.

Next, effects of the fifth example embodiment will be described.

According to the fifth example embodiment, the management state of the infrastructure can be compared between the companies. The reason is that the information acquisition unit 112 acquires the management information indicating the management state of the infrastructure of each of the plurality of companies, the ranking processing unit 113 calculates the score regarding the management state of each of the plurality of companies based on the management information of each of the plurality of companies, ranks the plurality of companies according to the calculated score, and the display control unit 114 displays the ranking of each of the plurality of companies on the display means.

(Hardware Configuration)

In each of the above-described example embodiments, each component of the ranking devices 11, 21, and 31, the degradation diagnosis device 12, and the terminal device 14 indicates a block of a functional unit. A part or all of each component of each device may be achieved by an arbitrary combination of a computer 500 and a program. This program may be recorded in a non-volatile recording medium. The non-volatile recording medium is, for example, a compact disc read only memory (CDROM), a digital versatile disc (DVD), a solid state drive (SSD), or the like.

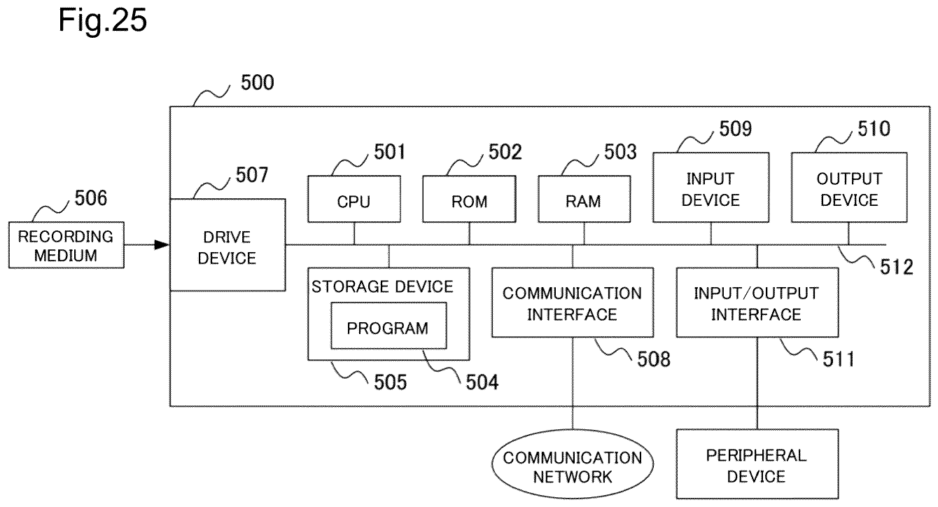

FIG. 25 is a block diagram illustrating an example of a hardware configuration of the computer 500. Referring to FIG. 25, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing instructions included in the program 504. For example, the CPU 501 of the ranking device 11 executes instructions included in the program 504 to implement the functions of the information acquisition unit 112, the ranking processing unit 113, and the display control unit 114. The RAM 503 may store data to be processed in each function of each device. For example, the RAM 503 of the ranking device 11 may store data (group information) of the group information storage unit.

The drive device 507 reads and writes the recording medium 506. The communication interface 508 provides an interface with a communication network. The input device 509 is, for example, a mouse, a keyboard, or the like, and receives an input of information from a company or the like. The output device 510 is, for example, a display, and outputs (displays) information to a company or the like. The input/output interface 511 provides an interface with a peripheral device. The bus 512 connects the components of the hardware. The program 504 may be supplied to the CPU 501 via a communication network, or may be stored in the recording medium 506 in advance, read by the drive device 507, and supplied to the CPU 501.

The hardware configuration illustrated in FIG. 25 is an example, and other components may be added or some components may not be included.

There are various modifications of the method of achieving each device. For example, each device may be achieved by an arbitrary combination of a computer and a program different for each component. A plurality of components included in each device may be achieved by an arbitrary combination of one computer and a program.

Some or all of the components of each device may be achieved by general-purpose or dedicated circuitry including a processor or the like, or a combination thereof. These circuits may be configured by a single chip or may be configured by a plurality of chips connected via a bus. A part or all of each component of each device may be realized by a combination of the above-described circuit or the like and a program.

In a case where a part or all of each component of each device is achieved by a plurality of computers, circuits, and the like, the plurality of computers, circuits, and the like may be arranged in a centralized manner or in a distributed manner.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.
(Supplementary Note 1)
An infrastructure management system including:
an acquisition means configured to acquire management information indicating a management state of an infrastructure of each of a plurality of companies;
a ranking means configured to calculate a score regarding a management state of each of the plurality of companies based on the management information of each of the plurality of companies, and rank the plurality of companies according to the calculated score; and
a display control means configured to display a ranking of each of the plurality of companies on a display means.
(Supplementary Note 2)
The infrastructure management system according to Supplementary Note 1, in which
the ranking means calculates, for each of the plurality of companies, a score of the company based on management information of the company and a coefficient according to a value of a predetermined company attribute of the company.
(Supplementary Note 3)
The infrastructure management system according to Supplementary Note 2, in which
the infrastructure is a road, and
the predetermined company attribute includes at least one of an attribute related to climate of an area to which a road managed by the company belongs, an attribute related to a terrain of the area, an attribute related to a road length managed by the company, and an attribute related to a road category of a road managed by the company.
(Supplementary Note 4)
The infrastructure management system according to any one of Supplementary Notes 1 to 3, in which
the infrastructure includes a plurality of management targets,
any of a plurality of values of a predetermined management attribute is assigned to each of the plurality of management targets, and
the ranking means calculates, for each of the plurality of values of the predetermined management attribute of each of the plurality of companies, a score of a management target to which the value is assigned, and calculates a score of the company by summing scores calculated for each of the plurality of values.
(Supplementary Note 5)
The infrastructure management system according to Supplementary Note 4, in which
the infrastructure is a road,
the management target is a section of the road, and
the predetermined management attribute includes at least one of an attribute related to a road category of the section, an attribute related to a material of a road surface of the section, an attribute related to climate of an area to which the section belongs, and an attribute related to a terrain of the area.
(Supplementary Note 6)
The infrastructure management system according to any one of Supplementary Notes 1 to 5, in which
when receiving a ranking request from a terminal device of one company, the ranking means ranks the plurality of companies including the one company.
(Supplementary Note 7)
The infrastructure management system according to Supplementary Note 6, in which
when displaying the rankings of the plurality of companies, the display control means displays companies other than the one company anonymously on the display means.
(Supplementary Note 8)
The infrastructure management system according to Supplementary Note 6 or 7, in which
when displaying the rankings of the plurality of companies, the display control means display a message according to a ranking of the one company on the display means.
(Supplementary Note 9)
The infrastructure management system according to any one of Supplementary Notes 6 to 8, in which
when displaying the rankings of the plurality of companies, the ranking means display a message according to a change in a ranking of the one company based on a history of the rankings of the plurality of companies on the display means.
(Supplementary Note 10)
The infrastructure management system according to any one of Supplementary Notes 6 to 9, further including:
a selection means configured to select a company whose value of a predetermined company attribute designated by the one company is the same as a value of the one company or within a predetermined range from the value of the one company from among a plurality of candidate companies, and set the selected company and the one company as the plurality of companies.
(Supplementary Note 11)
The infrastructure management system according to any one of Supplementary Notes 1 to 10, in which
the infrastructure is a road, and the management information is information related to degradation of the road.
(Supplementary Note 12)
The infrastructure management system according to Supplementary Note 11, in which
the road includes one or more routes,
the ranking means calculates a score related to a management state of each route of the plurality of companies, and ranks the routes of the plurality of companies according to the calculated score, and
the display control means display the rankings of the routes of the plurality of companies on the display means.
(Supplementary Note 13)
An infrastructure management method including:
acquiring management information indicating a management state of an infrastructure of each of a plurality of companies;
calculating a score regarding a management state of each of the plurality of companies based on the management information of each of the plurality of companies, and ranking the plurality of companies according to the calculated score; and
displaying a ranking of each of the plurality of companies on the display means.
(Supplementary Note 14)
A recording medium having stored therein a program causing a computer to execute:
acquiring management information indicating a management state of an infrastructure of each of a plurality of companies;
calculating a score regarding a management state of each of the plurality of companies based on the management information of each of the plurality of companies, and ranking the plurality of companies according to the calculated score; and
displaying a ranking of each of the plurality of companies on the display means.

### REFERENCE SIGNS LIST

10 infrastructure management system
11, 21, 31 ranking device
12 deterioration diagnosis device
13 infrastructure management DB
14 terminal device
111 group information storage unit
112 information acquisition unit
113 ranking processing unit
114 display control unit
125 company attribute information storage unit
126 coefficient information storage unit
137 company selection unit
500 computer
501 CPU
502 ROM
503 RAM
504 program
505 storage device
506 recording medium
507 drive device
508 communication interface
509 input device
510 output device
511 input/output interface
512 bus

What is claimed is:

1. An infrastructure management system comprising:
a memory storing instructions; and
one or more processors configured to execute the instructions to:
acquire management information indicating a management state of an infrastructure of each of a plurality of companies;
calculate a score regarding the management state of each of the plurality of companies based on the management information of each of the plurality of companies;
create rankings of the plurality of companies according to the calculated score; and
display the rankings of each of the plurality of companies on a display device.

2. The infrastructure management system according to claim 1, wherein
the one or more processors are further configured to execute the instructions to:
calculate, for each of the plurality of companies, the score of the company based on the management information of the company and a coefficient according to a value of a predetermined company attribute of the company.

3. The infrastructure management system according to claim 2, wherein
the infrastructure is a road, and
the predetermined company attribute includes at least one of an attribute related to climate of an area including a road managed by the company, an attribute related to a terrain of the area, an attribute related to a road length managed by the company, and an attribute related to a road category of a road managed by the company.

4. The infrastructure management system according to claim 1, wherein
the infrastructure includes a plurality of management targets,
any of a plurality of values of a predetermined management attribute is assigned to each of the plurality of management targets, and
the one or more processors are further configured to execute the instructions to:
calculate, for each of the plurality of values of the predetermined management attribute of each of the plurality of companies, a score of a management target to which the value is assigned, and calculate a score of the company by summing scores calculated for each of the plurality of values.

5. The infrastructure management system according to claim 4, wherein
the infrastructure is a road,
the management target is a section of the road, and
the predetermined management attribute includes at least one of an attribute related to a road category of the section, an attribute related to a material of a road surface of the section, an attribute related to climate of an area including the section, and an attribute related to a terrain of the area.

6. The infrastructure management system according to claim 1, wherein
the one or more processors are further configured to execute the instructions to:
upon receiving a ranking request from a terminal device of one company, create rankings of the plurality of companies including the one company.

7. The infrastructure management system according to claim 6, wherein
the one or more processors are further configured to execute the instructions to:
in displaying the rankings of each of the plurality of companies, display companies other than the one company anonymously on the display device.

8. The infrastructure management system according to claim 6, wherein
the one or more processors are further configured to execute the instructions to:
in displaying the rankings of each of the plurality of companies, display a message according to a ranking of the one company on the display device.

9. The infrastructure management system according to claim 6, wherein
the one or more processors are further configured to execute the instructions to:
in displaying the rankings of each of the plurality of companies, display a message according to a change in a ranking of the one company based on a history of the rankings of each of the plurality of companies on the display device.

10. The infrastructure management system according to claim 6, wherein
the one or more processors are further configured to execute the instructions to:
select a company whose value of a predetermined company attribute designated by the one company is the same as a value of the one company or within a predetermined range from the value of the one company from among a plurality of candidate companies, and set the selected company and the one company as the plurality of companies.

11. The infrastructure management system according to claim 1, wherein
the infrastructure is a road, and the management information is information related to degradation of the road.

12. The infrastructure management system according to claim 11, wherein
the road includes one or more routes, and
the one or more processors are further configured to execute the instructions to:
calculate a score related to a management state of each route of the plurality of companies, and create rankings of the routes of the plurality of companies according to the calculated score, and
display the rankings of the routes of the plurality of companies on the display device.

13. An infrastructure management method comprising:
acquiring management information indicating a management state of an infrastructure of each of a plurality of companies;
calculating a score regarding the management state of each of the plurality of companies based on the management information of each of the plurality of companies;
creating rankings of the plurality of companies according to the calculated score; and
displaying the rankings of each of the plurality of companies on a display device.

14. A recording medium having stored therein a program causing a computer to execute:
acquiring management information indicating a management state of an infrastructure of each of a plurality of companies;
calculating a score regarding the management state of each of the plurality of companies based on the management information of each of the plurality of companies;
creating rankings of the plurality of companies according to the calculated score; and
displaying the rankings of each of the plurality of companies on a display device.
